(19) United States
(12) Patent Application Publication
(10) Pub. No.: US 2007/0261289 A1
(43) Pub. Date: Nov. 15, 2007

(54) MODULAR REINFORCED SOFT BAIT LURE SYSTEM

(76) Inventor: James Benjamin Hobbins, Waunakee, WI (US)

Correspondence Address: FOLEY & LARDNER LLP, 150 EAST GILMAN STREET, P.O. BOX 1497, MADISON, WI, 53701-1497, US

(21) Appl. No.: 11/680,408

(22) Filed: Feb. 28, 2007

Related U.S. Application Data
(60) Provisional application No. 60/778,030, filed on Mar. 1, 2006.

(51) Int. Cl. A01K 85/00

(52) U.S. Cl. 43/42.24

(57) ABSTRACT

A soft bait fishing lure or lure component comprises a soft bait lure body and a fiber reinforcement shell molded within at least a portion of the soft bait lure body. The fiber reinforcement shell is multi-directionally flexible, and comprises one or more fiber strands, a plurality of apertures formed by the one or more fiber strands, and a micro-chamber. Each aperture within the plurality of apertures is capable of securing a hook.

### CROSS-REFERENCE TO RELATED APPLICATIONS

This application claims priority from U.S. Provisional Application No. 60/778,030, filed Mar. 1, 2006, incorporated herein by reference in its entirety.

### FIELD

The subject of the disclosure relates generally to soft bait fishing lures. More specifically, the disclosure relates to soft bait fishing lures and components which includes a fiber braid reinforcement shell such that the soft bait fishing lure is stronger and more environmentally friendly.

### BACKGROUND

Sports fishermen around the globe have been using soft bait and hard bait fishing lures for years. Soft bait lures come in many shapes and sizes and attempt to mimic live baits to target various fish species. An advantage of soft bait lures over hard bait lures is their flexibility and lifelike appearance. Soft bait lures can be made to convincingly mimic live baits in both appearance and movement.

A major disadvantage of soft bait lures is their durability. Traditional soft bait lures often rip and tear apart, resulting in lost fish, potential litter, and the cost of replacing the useless soft bait lure. Many soft bait lures are sold without hooks such that fisherman are often required to insert hooks while in the field. During the hook insertion process, portions of the soft bait lure are often ripped and torn off by the fisherman. Even if the lures do not rip during hook insertion, the hook creates holes in the lure, thereby lessening the overall strength of the lure. As a result, the soft bait lure often rips and tears apart as the fisherman attempts to cast the soft bait lure into the water. In some instances, the casting action causes the soft bait lure to be pulled too low on its hook sets such that the lure disengages from the hook and becomes ineffective for catching fish. If the soft bait lure reaches the water intact, there is a good chance that it will be torn apart when it is struck by a fish with sharp teeth. In addition, ultraviolet light, heat exposure over time, and aging in general all result in further soft bait lure deterioration and increase the chance that the soft bait lure will rip apart.

When soft bait lures rip, tear, or have improperly set hooks, fish catching opportunities are lost, fishing time is wasted in replacing lures, and expenses are incurred as fishermen purchase expensive, identically flawed replacement soft bait lures. In addition, the portions of soft bait lures which tear off are often lost in the field, resulting in undesirable and unsightly litter. Soft bait lure portions also end up on the surface or at the bottom of rivers, streams, lakes, seas, oceans, etc., and can cause environmental damage. In addition, the ripped off portions of soft bait lures can be swallowed by fish, causing undesirable harm to the fish population.

Over the years, several attempts have been made to create effective, resilient soft bait fishing lures which are less likely to rip apart. For example, U.S. Pat. Nos. 3,611,614; 3,909,974; 4,592,161; and 4,914,850 describe soft bait fishing which use an allegedly resilient material to prevent tearing and ripping of soft bait lures. Unfortunately, hooks and fish teeth cut right through these resilient materials causing the soft bait lure to rip and tear apart. U.S. Pat. Nos. 5,884,639; 6,148,830; and 6,794,440 describe various tear resistant multi-block elastomer and gelatinous copolymer compounds for use in soft bait lures. While these compounds may increase the stretch ability of soft lure baits, the soft bait lures themselves are still prone to tearing, ripping, and having their hook sets displaced.

U.S. Patent Application Publication No. 2005/0235550 describes a soft bait lure which includes two elastomeric regions (a hard region and a soft region) of differing strength values. The hard elastomeric region causes the soft bait lure to lose its flexibility and ability to mimic live bait. In addition, the hard region and the soft region are prone to being ripped apart as the lure is used in the field, and body sections of the soft bait lure can still be torn off. U.S. Patent Application Publication No. 2006/0008445 describes an environmentally friendly soft bait lure which is composed of 100% biodegradable material. The biodegradable material is a fibrous collagen matrix which is supposed to provide tear resistant properties. Soft bait lures composed of the fibrous collagen matrix suffer the same disadvantages of hook set slipping, ripping, and tearing apart. In addition, these lures are prone to unwanted decomposition in the water, in moist tackle boxes, and in other areas in which the lures contact moisture.

U.S. Pat. Nos. 2,741,058; 2,874,048; 3,685,197; 3,967,406; and 4,654,995 describe soft bait lures which include a rigid mesh or wire to increase lure strength. Soft bait lures with rigid inserts lack the ability to realistically mimic live bait. The rigid structures result in soft bait lures which lack the flexibility to move in a plurality of planes. In addition, the rigid inserts adversely affect the softness, weight, and action of the soft bait lure. U.S. Pat. Nos. 2,563,522; 2,722,766; 3,429,066; 3,440,757; and 3,537,207 also describe soft bait lures with rigid and/or heavy inserts. These inserts are too heavy, lack life-like action, texture and feel, and result in cumbersome and static soft bait lures.

U.S. Pat. Nos. 3,449,853 and 3,831,307 describe soft bait lures which include yarn and knotted string internal cores with external bell attachments. These soft bait lures are difficult to hook and use in the field effectively. The hooks can easily by snagged and get caught within the lure core, resulting in a useless lure. In addition, the yarn does not provided the necessary strength to prevent lure destruction. U.S. Pat. No. 4,998,372 describes a soft bait lure which includes a slotted ‘T’ laminate with hinge slots designed to produce erratic action in the lure. The lure can be susceptible to lure tear off at the hinge and lure destruction of other resilient portions of the lure during fish strikes. U.S. Pat. No. 5,142,811 describes a soft bait lure which includes an embedded rigid hollow tubular casing to receive hook and line sets. The tubular casing is inflexible and results in a lure which is unable to imitate live bait. U.S. Pat. No. 6,662,487 describes a soft bait lure of notched architecture with slots manufactured at notched lure intersections. The soft bait lure also includes an innermost core. The soft bait lure insert provides little structural protection, and portions of the lure can still be torn off. In addition, the innermost core can slide within the lure and/or be separated from the rest of the lure during fish strikes.

Thus, there is a need for a soft bait fishing lure which includes an internal shell such that the lure is not susceptible to being ripped or torn apart during fish strikes and hook setting. Further, there is a need for a soft bait fishing lure with a flexible internal shell such that the body of the fishing lure can move in an any plane. Further yet, there is a need for a soft bait fishing lure in which hooks can easily be locked into place such that the hooks are not able to slide within the lure.

### SUMMARY

An exemplary soft bait fishing lure is provided. The soft bait fishing lure comprises a soft bait lure body and a fiber reinforcement shell molded within at least a portion of the soft bait lure body. The fiber reinforcement shell is multi-directionally flexible, and comprises one or more fiber strands, a plurality of apertures formed by the one or more fiber strands, and a micro-chamber. Each aperture within the plurality of apertures is capable of securing a hook.

An exemplary soft bait fishing system is also provided. The soft bait fishing system comprises a soft bait fishing lure comprising a soft bait lure body comprising an elastomer. The soft bait fishing system further comprises a fiber reinforcement shell molded within at least a portion of the soft bait lure body. The fiber reinforcement shell comprises one or more fiber strands, a plurality of apertures formed by the one or more fiber strands, and a micro-chamber capable of receiving a micro-insert. The soft bait fishing system further comprises a hook comprising a curved portion.

An exemplary fiber reinforcement shell for use in a soft bait fishing lure is also provided. The fiber reinforcement shell comprises one or more fiber strands and a plurality of apertures formed by the one or more fiber strands. Each aperture within the plurality of apertures is capable of receiving at least a portion of a hook, and the plurality of apertures is multi-directionally flexible. The fiber reinforcement shell further comprises a micro-chamber formed at least in part by the plurality of apertures. The micro-chamber is capable of receiving a micro-insert.

### BRIEF DESCRIPTION OF THE DRAWINGS

Exemplary embodiments will hereafter be described with reference to the accompanying drawings.

FIGS. 1A and 1B illustrate perspective views of a fiber braid reinforcement shell for a soft bait lure in accordance with an exemplary embodiment.

FIG. 2 is an inside view of a circular fiber braid reinforcement shell for a soft bait lure in accordance with an exemplary embodiment.

FIG. 3 is a partial inside view of an ovular fiber braid reinforcement shell for a soft bait lure in accordance with an exemplary embodiment.

FIG. 4 is a side view of the fiber braid reinforcement shell in accordance with an exemplary embodiment.

FIG. 5 is an internal side view of a multi-diameter fiber braid reinforcement shell in accordance with an exemplary embodiment.

FIG. 6 is an internal side view of a uniform fiber braid reinforcement shell in accordance with an exemplary embodiment.

FIG. 7 is an internal side view of a plurality of fiber braid reinforcement shells for use in distinct locations of a soft bait lure in accordance with an exemplary embodiment.

FIG. 8 is an internal side view of a layered fiber braid reinforcement shell in accordance with an exemplary embodiment.

FIG. 9 is a cut-away perspective view of a fiber braid reinforcement shell with an open micro-chamber in accordance with an exemplary embodiment.

FIG. 10 is a cut-away perspective view of a fiber braid reinforcement shell with a closed micro-chamber in accordance with an exemplary embodiment.

FIG. 11A is a cut-away perspective view of a layered fiber braid reinforcement shell with a closed micro-chamber in accordance with an exemplary embodiment.

FIG. 11B is a cut-away perspective view of a layered fiber braid reinforcement shell with an open micro-chamber in accordance with an exemplary embodiment.

FIG. 12 illustrates cross sectional views of a plurality of soft bait lures which include various fiber braid reinforcement shell configurations in accordance with an exemplary embodiment.

FIG. 13 illustrates cross sectional views of a plurality of soft bait lures which include various fiber braid reinforcement shell configurations with closed micro-chambers in accordance with an exemplary embodiment.

FIG. 14 illustrates cross sectional views of a plurality of soft bait lures which include various fiber braid reinforcement shell configurations with sectioning in accordance with an exemplary embodiment.

FIG. 15 is a cut-away perspective view of a fiber braid reinforcement shell with an open micro-chamber in accordance with an exemplary embodiment.

FIG. 16 is a cut-away perspective view of a hook locked in place by a fiber braid reinforcement shell in accordance with an exemplary embodiment.

FIG. 17 is a cut-away perspective view of a hook locked in place by a layered fiber braid reinforcement shell in accordance with an exemplary embodiment.

FIGS. 18-20 are perspective views of barbed hooks locked in place by one or more fiber braid reinforcement shells in accordance with an exemplary embodiment.

FIG. 21 is a side view of a calibrated line threading mechanism in accordance with an exemplary embodiment.

FIG. 22 is a side view of a calibrated micro-insert plunger in accordance with an exemplary embodiment.

FIG. 23 illustrates a plurality of micro-inserts in accordance with an exemplary embodiment.

FIG. 24 is a cross sectional view of a worm-shaped soft bait lure which includes micro-inserts in accordance with an exemplary embodiment.

FIG. 25 is a perspective view of a crawfish soft bait lure in accordance with an exemplary embodiment.

FIG. 26 is a side view of a shad soft bait lure in accordance with an exemplary embodiment.

FIG. 27 is a cut-away perspective view of a tube-shaped soft bait lure in accordance with an exemplary embodiment.

FIG. 28 is a side view of micro-fiber flocking reinforcement incorporated into an elastomer in accordance with an exemplary embodiment.

### DETAILED DESCRIPTION

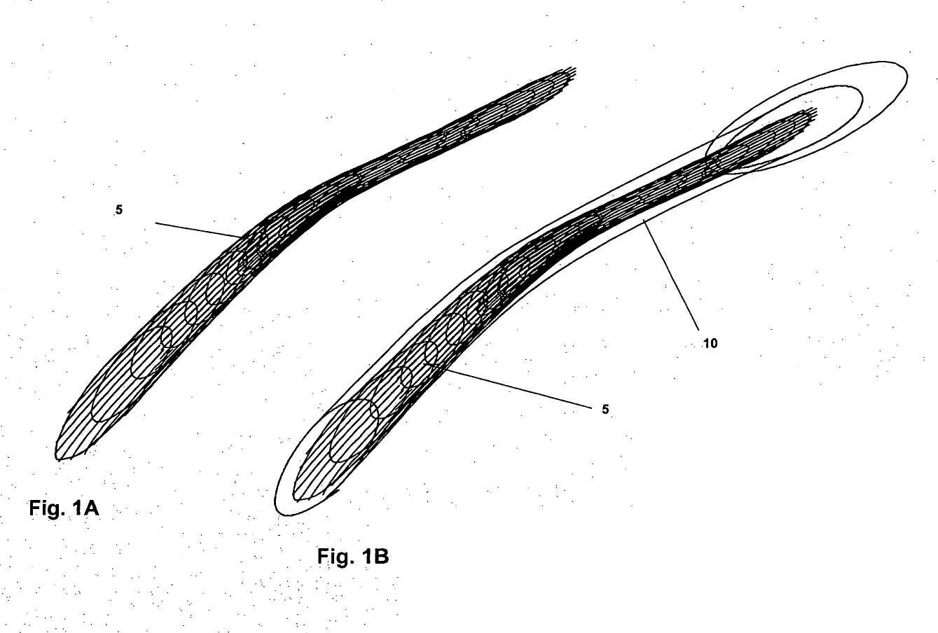

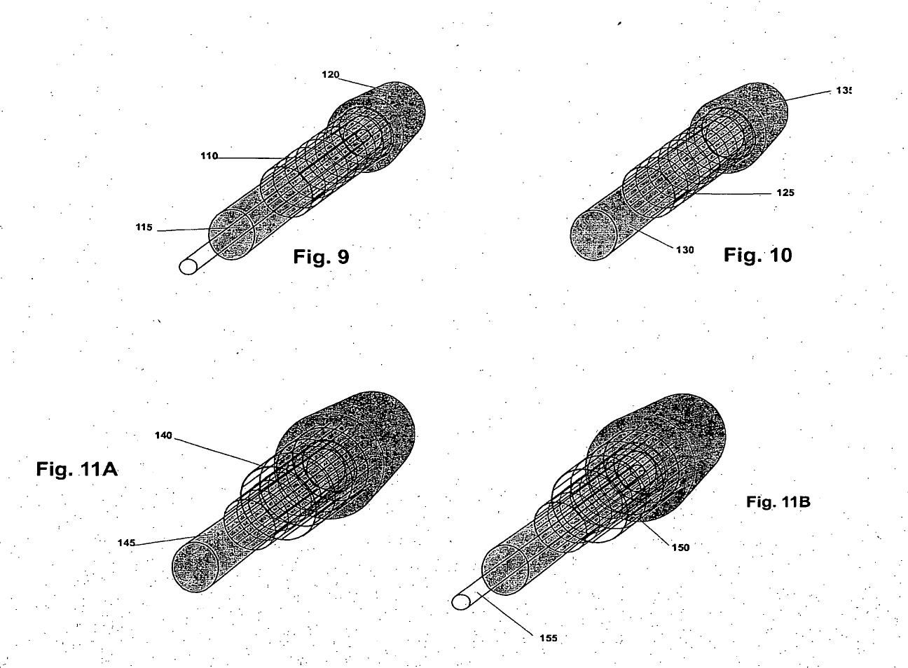

FIG. 1 illustrates perspective views of a fiber braid reinforcement shell 5 for a soft bait lure in accordance with an exemplary embodiment. FIG. 1A is a perspective view of the fiber braid reinforcement shell (FBRS) 5 prior to being incorporated into the soft bait lure. FIG. 1B is a perspective view of the FBRS 5 incorporated within a body 10 of the soft bait lure. In an exemplary embodiment, the FBRS 5 can be completely enclosed within the body 10. Alternatively, one or more portions of the FBRS 5 may extend outward from the body 10. In one embodiment, an end of the FBRS 5 can be flush with an outer edge of the body 10 such that hooks and other inserts can easily be placed within a micro-chamber of the FBRS 5. The micro-chamber is described in more detail with reference to FIGS. 9-11.

The FBRS 5 can be used to provide a soft bait lure which is both strong and flexible. The fiber used to create the FBRS 5 can be made from any combination of natural, synthetic, and/or metallic material. For example, the fiber in the FBRS 5 can be linen fiber, cotton fiber, rayon fiber, polyester fiber, dacron fiber, polyethylene fiber, polyvinyl fiber, acrylic fiber, olefin fiber, nylon fiber, nylon hybrid fiber, mylar fiber, Kevlar fiber, carbon and/or graphite fiber, stainless steel fiber, any other polymer plastic fiber, any other metallic fiber, etc. The specific material used can depend on the desired tensile strength of the shell, the desired flexibility of the shell, and the desired properties of the soft bait lure. The FBRS 5 is not meant to be limited to fibers which are braided together. The FBRS 5 can be created using any fiber braiding, weaving, meshing, netting, honeycombing, etc. method known to those of skill in the art. In an exemplary embodiment, the FBRS 5 can be composed of a plurality of single fiber strands. Alternatively, the FBRS 5 can be composed of a plurality of multi-fiber strands. The multi-fiber strands can be composed from one or more single fiber strands which are braided, weaved, or twisted or otherwise bound together. The individual fiber strands used to create the multi-fiber strands can be of the same type, or different such that each multi-fiber strand can include a plurality of fiber types. In one embodiment, a single fiber strand can be used to create the FBRS 5. The fiber strand(s) used to create the FBRS 5 can be of any diameter depending on the desired tensile strength, desired flexibility, desired weight, and other factors. The FBRS 5 can be created at any length and any diameter (or width) such that a vast array of soft bait lures can be created. For example, an FBRS for insertion in a soft bait lure used to catch perch can be several inches in length, an FBRS for insertion in a soft bait lure used to catch musky can be a foot or more in length, and an FBRS for insertion in a soft bait lure used to catch tuna or marlin can be several feet or more in length.

In an exemplary embodiment, the fiber braid reinforcement shell (FBRS) 5 can be multi-directionally flexible such that the soft bait lure is flexible in a plurality of planes. For example, the FBRS 5 can allow flexibility within a plane which is parallel to a water surface. By twitching his/her fishing pole from side to side, a fisherman can cause the FBRS 5 and the body 10 of the soft bait lure to slither through the water similar to a snake or centipede. The FBRS 5 can also allow flexibility within a plane which is perpendicular to the water surface such that the fisherman can cause the FBRS 5 and the body 10 of the soft bait lure to go up and down in the shape of a sinusoid. The FBRS 5 can also provide flexibility in planes at any other angles relative to the surface of the water. In addition, the FBRS can allow the soft bait lure to move simultaneously in a plurality of such planes. For example, a front portion of the soft bait lure can be made to wiggle from left to right while a rear portion of the soft bait lure is made to wiggle up and down.

In an exemplary embodiment, the body 10 of the soft bait lure can be made from any resilient material which is capable of being molded to the fiber braid reinforcement shell 5. For example, the body 10 of the soft bait lure can be made from any type of elastomer. In an exemplary embodiment, the elastomer or other material used to create the body 10 can include a flavor and/or scent attractant capable of attracting fish. Alternatively, an attractant may not be incorporated into the body 10. In alternative embodiments, the body 10 of the soft bait lure can be made from any combination of elastomer, plastic, plastisol, polyvinyl, rubber, gelatin, flavoring additive, and any other resilient material used in soft bait lure manufacturing as known to those skilled in the art. Alternatively, the body 10 can be made from any other material known to those of skill in the art. In an exemplary embodiment, the FBRS 5 can be placed in the body 10 of the soft bait lure during a molding process used to create the body. In one embodiment, a co-extrusion molding process can be used during which the FBRS 5 and the body 10 of the soft bait lure are extruded and molded simultaneously. Alternatively, any other molding process known to those of skill in the art can be used. For example, the soft bait lure can be created by injection, extrusion, pouring, dipping, rotary molding, etc.

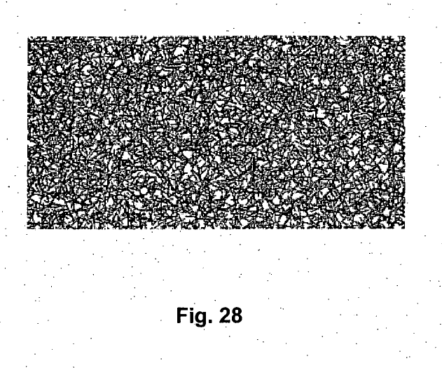

In one embodiment, natural and/or artificial micro-fiber flocking reinforcements can be compounded into the body 10 of the soft bait lure to provide additional reinforcement to body 10 of the soft bait lure. The micro-fiber flocking reinforcements can be composed from any natural and/or synthetic micro-fiber which is capable of being compounded with an elastomer or other material used to form the body 10 of the soft bait lure. FIG. 28 illustrates micro-fiber flocking reinforcement incorporated into an elastomer in accordance with an exemplary embodiment. In an exemplary embodiment, the micro-fiber flocking reinforcements can crosshatch and cure together within the elastomer compound during the molding process. In one embodiment, the micro-fiber flocking reinforcements can include a flavor or scent which is capable of attracting a fish.

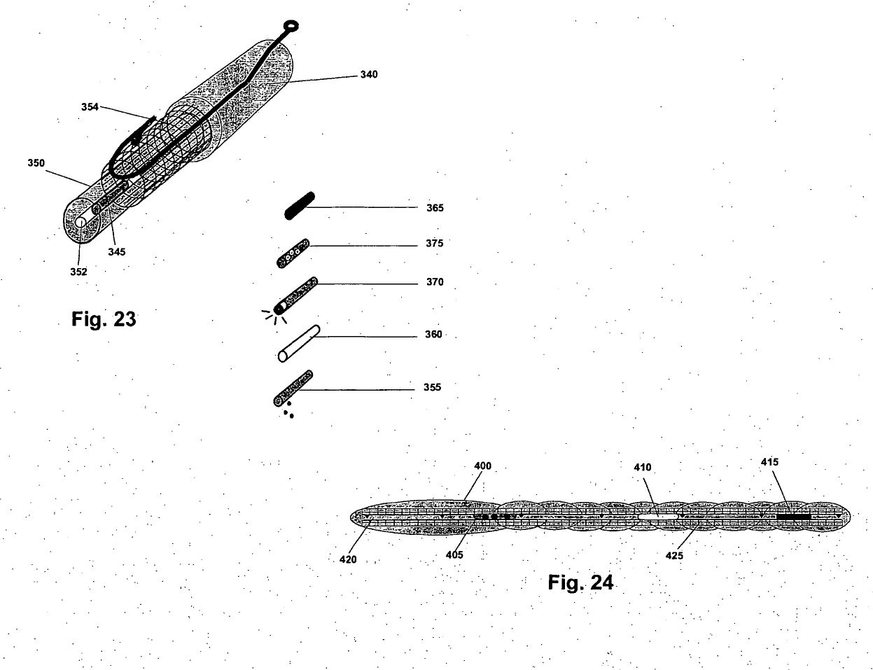

In an exemplary embodiment, the FBRS 5 can be used to vary properties of the soft bait lures in which the FBRS 5 is to be placed. For example, a diameter, weight, length, strength, expandability, color, shimmer, and shape of the soft bait lure can all be altered by adjusting the FBRS 5. These properties can be controlled by the fiber material used to create the FBRS 5 and/or coating or other materials applied to the FBRS 5. For example, a lightweight FBRS can be used in soft bait lures which are to float on the surface of the water and a heavier FBRS can be used in deep diving soft bait lures. The weight of the FBRS can depend on the fiber with which the FBRS is constructed. Similarly, in soft bait lures with translucent or transparent bodies, the FBRS can be made to shimmer such that fish are more attracted to the soft bait lure. The shimmer can be provided by the fiber material used to create the FBRS and/or a paint or other coating applied to the FBRS. The tensile strength of the FBRS can also be altered by the strength of the fiber used to create the FBRS. A desired tensile strength can depend on the fish species for which the soft bait lure is to be used (i.e., higher tensile strength for larger fish). In translucent or transparent soft bait lures, the FBRS can be also used to control the interior color of the soft bait lure. For example, the fibers of the FBRS can be selected, painted, or coated such that the fibers are the color capable of attracting fish. In an exemplary embodiment, the FBRS can also be expandable such that oversized inserts can be securely locked in place within the FBRS. Inserts are described in more detail with reference to FIG. 23.

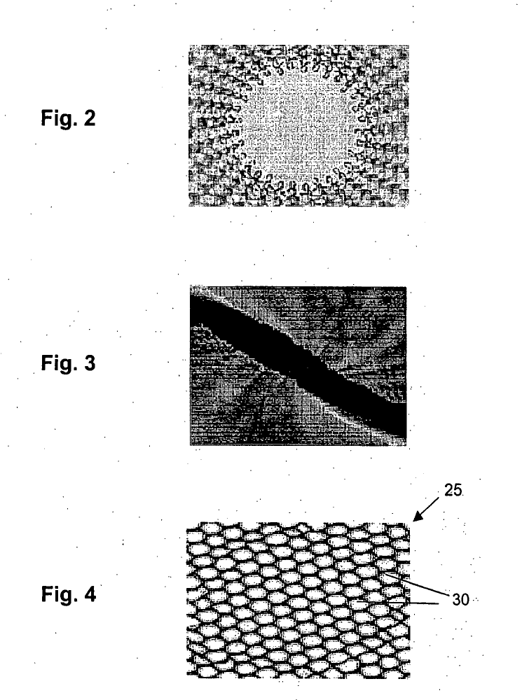

FIG. 2 is an inside view of a circular fiber braid reinforcement shell (FBRS) for a soft bait lure in accordance with an exemplary embodiment. The FBRS diameter illustrated with reference to FIG. 2 is not meant to be limiting. Fiber braid reinforcement shells can be made with any diameter(s), depending on a desired size of the soft bait lure. FIG. 3 is a partial inside view of an ovular fiber braid reinforcement shell for a soft bait lure in accordance with an exemplary embodiment. In alternative embodiments, the FBRS can be any other shape including square, triangular, rectangular, octagonal, etc.

FIG. 4 is a side view of a fiber braid reinforcement shell 25 in accordance with an exemplary embodiment. The FBRS 25 includes a plurality of apertures 30 capable of receiving hooks and keeping them substantially locked in place. The size of the apertures 30 illustrated with reference to FIG. 2 is not meant to be limiting. In alternative embodiments, there can be more or less space between the fibers such that the apertures 30 can be larger or smaller. For example, a loosely spaced FBRS can be used to create a soft bait lure with enhanced flexibility. Similarly, a more tightly spaced FBRS can be used to further enhance the strength of the soft bait lure.

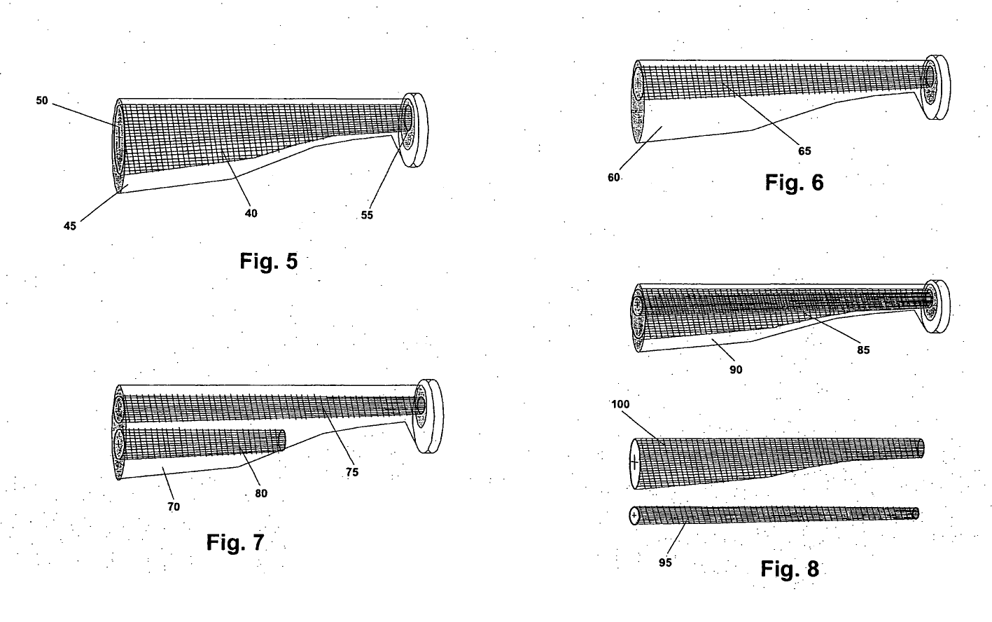

In an exemplary embodiment, fiber braid reinforcement shells of various shapes, sizes, and configurations can be used in various soft bait lures. As an example, FIG. 5 is an internal side view of a multi-diameter fiber braid reinforcement shell 40 within a body 45 in accordance with an exemplary embodiment. The multi-diameter FBRS 40 is a first (larger) diameter at a first end 50, and a second (smaller) diameter at a second end 55. The multi-diameter FBRS 40 tapers in a non-uniform manner along its bottom. Alternatively, the multi-diameter FBRS 40 can taper in a uniform manner such that it forms a partial cone. In another alternative embodiment, there may not be a taper, but rather an abrupt, ninety degree boundary between the first diameter and the second diameter. FIG. 6 is an internal side view of a fiber braid reinforcement shell 65 which is uniform in diameter and within a body 60 of a soft bait lure in accordance with an exemplary embodiment.

FIG. 7 is an internal side view of a plurality of fiber braid reinforcement shells for use in distinct locations of a body 70 of a soft bait lure in accordance with an exemplary embodiment. A first FBRS 75 is of a greater length than a second FBRS 80. In alternative embodiments, any or all of a plurality of fiber braid reinforcement shells can be the same length. In one embodiment, any of the properties of FBRSs within the plurality of FBRSs can differ. For example, a first FBRS can be adapted to shimmer and a second FBRS can be painted green, or the tensile strength of a first FBRS can differ from the tensile strength of a second FBRS. In an exemplary embodiment, a soft bait lure can include any number of individual FBRSs, including three, four, five, etc. The FBRSs can be placed side by side within the soft bait lure, on top of one another, or at any other orientation with respect to one another.

FIG. 8 is an internal side view of a layered fiber braid reinforcement shell 85 in accordance with an exemplary embodiment. A first FBRS 95 is adapted to fit inside of a second FBRS 100 to form the layered FBRS 85 within a body 90 of a soft bait lure. In alternative embodiments, the layered FBRS 85 can include three, four, five, or any other number of individual FBRSs layered within one another. The layered FBRSs can be the same shape or different, depending on the embodiment. In an exemplary embodiment, the layered FBRS 85 can be used to provide a stronger soft bait lure and/or to enhance the ability of the FBRS to lock a hook in place.

In an exemplary embodiment, an interior of an FBRS can be referred to as a micro-chamber. In another exemplary embodiment, an FBRS can either have an open micro-chamber or a closed micro-chamber. An open micro-chamber can refer to a micro-chamber which is not filled with the resilient material used to create the body of the soft bait lure or any other material such that one or more chambers exist in the interior of the soft bait lure. A closed micro-chamber can refer to a micro-chamber which is filled with the resilient material used to create the body of the soft bait lure such that there is no open space in the interior of the soft bait lure. Alternatively, the closed micro-chamber can be filled with any other material. For example, the closed micro-chamber can be filled in part with natural and/or artificial micro-fiber flocking reinforcements to provide additional reinforcement to the soft lure. In an exemplary embodiment, a closed micro-chamber can be used in soft bait lures in which hooks, line, and/or any other micro-inserts are molded into the soft bait lure by the soft bait lure manufacturer. Open micro-chambers can be used in soft bait lures in which the user manually inserts, hooks, line, and/or any other micro-inserts into the soft bait lure. The open micro-chamber can make it easier to access and manipulate any inserts desired by the user. Alternatively, users can place inserts in soft bait lures with closed micro-chambers and/or manufacturers can place inserts into soft bait lures with open micro-chambers. In an exemplary embodiment, the molding process used to create the soft bait lure can be used to control whether the micro-chamber is open or closed.

FIG. 9 is a cut-away perspective view of a fiber braid reinforcement shell (FBRS) 110 with an open micro-chamber 115 in accordance with an exemplary embodiment. The FBRS 110 is in a body 120 of a soft bait lure. In an exemplary embodiment, the open micro-chamber 115 can run the length of the FBRS 110. Alternatively, the open micro-chamber 115 can be shorter than or longer than the FBRS 110. In one embodiment, a diameter of the open micro-chamber 115 can be approximately the same diameter as the FBRS 110 in which the open micro-chamber 115 is located. Alternatively, the diameter of the open micro-chamber 115 can be smaller or larger than the diameter of the FBRS 110. In one embodiment, the open micro-chamber 115 can be divided into a plurality of sub-chambers such that there are a plurality of open micro-chambers within a single FBRS. In embodiments which include a plurality of FBRSs, each individual FBRS can include one or more open micro-chambers. In one embodiment, the open micro-chamber 115 can include a hollow tube-shaped insert. The hollow tube-shaped insert can be a flexible plastic tube, a cloth tube, an FBRS such that a layered FBRS is formed, or any other insert which does not inhibit the multi-directional flexibility of the soft bait lure. The hollow tub-shaped insert can be smooth or notched depending on the embodiment. Open micro-chambers which do not include the hollow tube can also be smooth or notched, depending on the embodiment. Notches can be molded into the elastomer (or other material) during molding of the soft bait lure. FIG. 10 is a cut-away perspective view of a fiber braid reinforcement shell 125 with a closed micro-chamber 130 in accordance with an exemplary embodiment. The closed micro-chamber can be filled with the same material used to create a body 135 of the soft bait lure, or a different material, depending on the embodiment.

FIG. 11A is a cut-away perspective view of a layered fiber braid reinforcement shell 140 with a closed micro-chamber 145 in accordance with an exemplary embodiment. FIG. 11B is a cut-away perspective view of a layered fiber braid reinforcement shell 150 with an open micro-chamber 155 in accordance with an exemplary embodiment. In an exemplary embodiment, the open micro-chamber(s) in a layered FBRS can be within the innermost individual FBRS. Alternatively, one or more open micro-chambers can be placed in between adjacent fiber braid reinforcement shells which make up the layered FBRS.

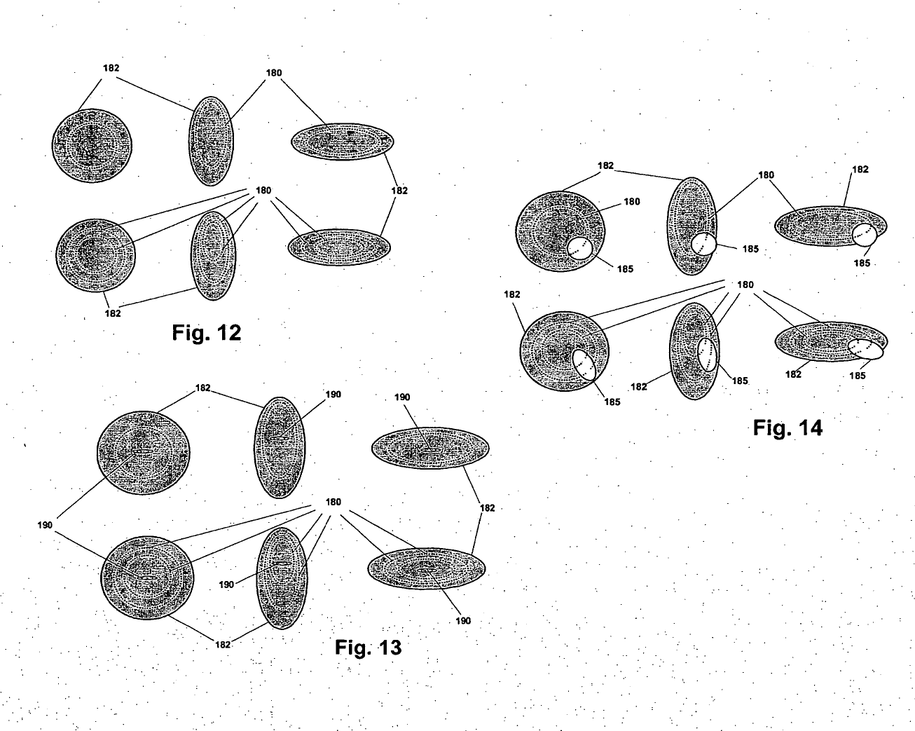

FIG. 12 illustrates cross sectional views of a plurality of soft bait lures which include various configurations of a fiber braid reinforcement shell (FBRS) 180 in accordance with an exemplary embodiment. In an exemplary embodiment, there can be a plurality fiber braid reinforcement shell 180 within a single body 182 of a soft bait lure. The plurality of FBRS 180 can be inside of one another (layered), side by side, on top of one another, etc. FIG. 13 illustrates cross sectional views of a plurality of soft bait lures which include various configurations of the fiber braid reinforcement shell 180 with sections 185 in accordance with an exemplary embodiment. The sections 185 can be used to add modular flexibility to the FBRS 180 such that the FBRS 180 can be used to create magnum or other soft bait lures. The sections 185 can refer to channels or cavities molded into the soft bait lure and capable of receiving hook and/or lure sets such that a hybrid soft bait lure can be formed. In an exemplary embodiment, the FBRS 180 can wrap around hooks and lure sets within the sections 185 in a tubular fashion, while preserving the expandable, multi-directionally flexible properties of the soft bait lure. The sections 185 can run a partial length or the entire length of the soft bait lure body, depending on the embodiment. In one embodiment, the hook and/or lure sets can be molded into the body 182 during the molding process used to form the body 182. Alternatively, the hook and/or lure sets can be inserted after the body 182 is formed. FIG. 14 illustrates cross sectional views of a plurality of soft bait lures which include various configurations of the fiber braid reinforcement shell 180 with open micro-chambers 190 in accordance with an exemplary embodiment. In alternative embodiments, the FBRSs can be any other shapes and/or placed in any other configuration within the soft bait lure. Similarly, the open micro-chambers 190 can be any other shape and/or placed in any other configuration within the soft bait lure.

In an exemplary embodiment, an FBRS can also be used within soft bait components which are used to form a hybrid or combination fishing lure. The soft bait component can be a leg which extends from the hybrid fishing lure, a tail which extends from the hybrid fishing lure, a portion of a body of the hybrid fishing lure, or any other portion of the hybrid fishing lure. For example, a hybrid musky fishing lure can include a hard plastic body and a soft bait tail with an FBRS. In an exemplary embodiment, the soft bait tail can be a mix and match tail which can easily be attached to and/or removed from the hybrid fishing lure. Alternatively, the soft bait tail can be permanently mounted to the hybrid fishing lure.

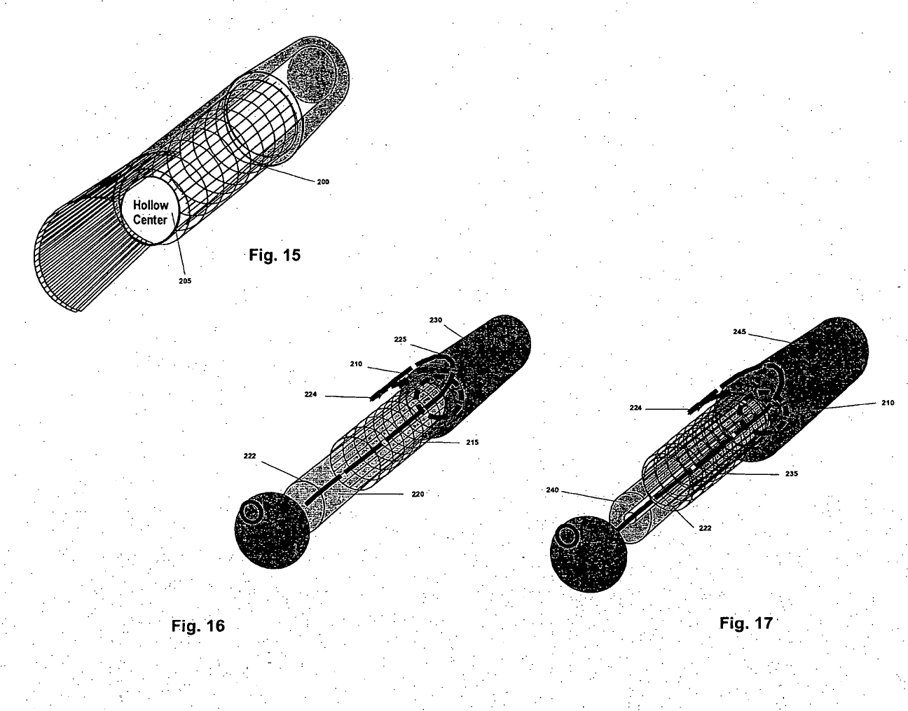

FIG. 15 is a cut-away perspective view of a fiber braid reinforcement shell 200 with an open micro-chamber 205 in accordance with an exemplary embodiment. The open micro-chamber 205 includes a hollow center which is capable of receiving a hook body, fishing line, and/or other micro-inserts. In one embodiment, the hollow center of the open micro-chamber can include a hollow tube-shaped or other insert capable of receiving inserts. The open micro-chamber and/or the hollow tube can be smooth or notched depending on the embodiment. Notches in a notched open micro-chamber can act as locking mechanisms for holding inserts in place.

FIG. 16 is a cut-away perspective view of a hook 210 locked in place by a FBRS 215 with a closed micro-chamber 220 in accordance with an exemplary embodiment. The hook 210 includes a shaft 222, a point 224, and a curved portion 225. The point 224 of the hook 210 extends through a body 230 of the soft bait lure, and is substantially locked in place through contact between the curved portion 225 of the hook 210 and the FBRS 215. In an exemplary embodiment, the body 230 of the soft bait lure helps keep the hook 210 substantially locked in place. FIG. 17 is a cut-away perspective view of the hook 210 substantially locked in place within a layered FBRS 235 with an open micro-chamber 240 in accordance with an exemplary embodiment. The point 224 of the hook 210 extends through a body 245 of the soft bait lure and is substantially locked in place through contact between the curved portion 225 of the hook 210 and the layered FBRS 235. In an exemplary embodiment, the body 245 of the soft bait lure also helps keep the hook 210 substantially locked in place.

In an exemplary embodiment, hooks can be locked in place manually in the field by a user. In an exemplary embodiment, a soft bait lure can include a front end (to which fishing line can be tied) and a back end which trails in the water. A user can insert a point of the hook into a micro-chamber of the FBRS and position the hook such that the point is pointing toward the front of the soft bait lure. The user can push the hook toward the back end of the soft bait such that the curved portion of the hook passes through the micro-chamber and the point of the hook does not get caught in the FBRS. Upon inserting the hook to a desired position, the user can pull the hook forward and cause the point and at least a portion of the curved portion of the hook to go through the FBRS and come out of the body of the soft bait lure. The user can pull the hook forward until it is substantially locked in place through contact between the hook and the fibers of FBRS. In an exemplary embodiment, at least a portion of the shaft of the hook can remain in the micro-chamber. As a result, the hook can be locked within an aperture of the plurality of apertures that make up the FBRS. In an exemplary embodiment, any movement of the hook may be limited to the size of the aperture through which the hook is inserted. However, the movement of the hook is limited by the body of the soft bait lure such that overall hook movement can be minute. In an alternative embodiment, the hook can be inserted in the opposite direction, i.e., from the back end of the lure to the front end of the lure.

In one embodiment, the hook can be locked into the FBRS of the soft bait lure such that the shaft of the hook is perpendicular to the FBRS. For example, the user can cause the point of the hook to pierce the body of the soft bait lure on a first side, pierce the FBRS on a first side, go through the micro-chamber of the FBRS, pierce the FBRS on a second side, and pierce the body of the soft bait lure on a second side. In alternative embodiments, the user can insert the hook by any method such that the hook is locked in place by the FBRS. In an exemplary embodiment, the user can insert hooks into soft bait lures which include an open micro-chamber. Alternatively, users can also insert hooks into soft bait lures which include a closed micro-chamber. In an exemplary embodiment, the hook can be any type of fishing hook known to those of skill in the art, including a barbed hook, a barbless hook, a single hook, a treble hook, a weighted hook, a floating hook, a jig hook, a hook attached to a hard or soft lure, etc.

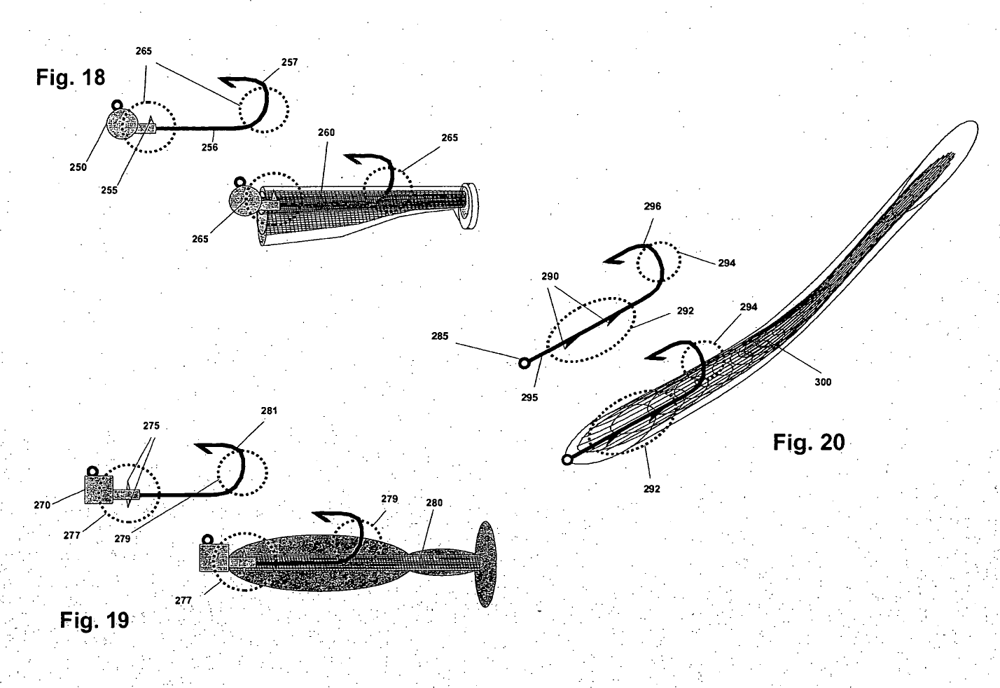

FIGS. 18-20 are internal perspective views of barbed hooks locked in place by one or more fiber braid reinforcement shells in accordance with an exemplary embodiment. In an exemplary embodiment, the barbs on the hooks can function as additional locking points such that the hook is further secured to the FBRS. FIG. 18 illustrates a barbed hook 250 which includes a barb 255, a shaft 256, and a curved portion 257. In an exemplary embodiment, the barb 255 and the curved portion 257 can be locking points 265 at which the barbed hook 250 is locked to a layered FBRS 260. FIG. 19 illustrates a barbed hook 270 which includes two barbs 275 for locking into an FBRS 280. As such, the barbed hook 270 can include two locking points 277 at the location of the barbs 275 and one locking point 279 at the location of a curved portion 281 of the barbed hook 270. FIG. 20 illustrates a barbed hook 285 which includes two barbs 290 on a shaft 295 of the barbed hook 285 for locking into an FBRS 300. The barbed hook 285 can be locked to the FBRS 300 at two locking points 292 at the location of the two barbs 290 and a single locking point 294 at the location of a curved portion 296 of the barbed hook 285. In alternative embodiments, any other style of hook can be used. Further, the hooks used can include any configuration and/or number of barbs.

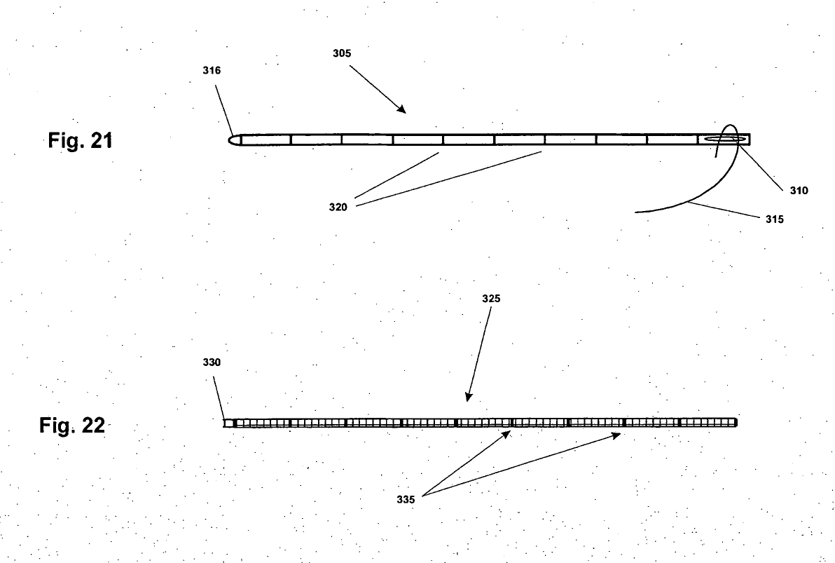

FIG. 21 is a side view of a calibrated line threading mechanism 305 in accordance with an exemplary embodiment. In alternative embodiments, the line threading mechanism 305 may not be calibrated. The line threading mechanism 305 can include a line receiving aperture 310 capable of receiving fishing line 315. In an exemplary embodiment, the line threading mechanism 305 can be used to set hooks within an FBRS and/or run fishing line through the FBRS. In an exemplary embodiment, a user can thread fishing line 315 through the line receiving aperture 310 and push the line threading mechanism 305 into and through at least a portion of a micro-chamber such that the fishing line 315 runs through at least a portion of the FBRS and the soft bait lure. The user can push the line threading mechanism 305 at a blunt end 316 such that the user does not damage his/her fingers. The line threading mechanism 305 also includes a calibration scale 320 which can be used to gauge distances in a soft body lure with a non-transparent, non-translucent body. As such, the user can easily run the fishing line 315 through a specific length of the soft body lure without having to guess. In an exemplary embodiment, the fishing line 315 can have one or more hooks tied to it such that the line threading mechanism can also be used to set and lock hooks within the soft bait lure.

FIG. 22 is a side view of a calibrated micro-insert plunger 325 in accordance with an exemplary embodiment. The micro-insert plunger 325 can be used to insert and/or remove various micro-inserts into a micro-chamber of an FBRS. The micro-insert plunger 325 includes a concave tip 330 capable of receiving a micro-insert such that the micro-insert can be positioned within a micro-chamber. In an exemplary embodiment, a micro-insert can be inserted into the concave tip 330 and a user can insert the micro-insert plunger 325 into a micro-chamber of an FBRS. The user can push the micro-insert plunger 325 until the micro-insert is at a desired location and remove the micro-insert plunger 325. In an exemplary embodiment, the micro-insert can be held in place by any of the plurality of apertures which form the FBRS. Alternatively, the micro-insert can be held in place by one or more notches within the micro-chamber of the FBRS. In one embodiment, oversized micro-inserts can be used. The oversized micro-inserts can be held in place by friction with a micro-chamber of smaller diameter. In an exemplary embodiment, the micro-chamber of smaller diameter can expand along with the expandable FBRS. The one or more notches can be in a hollow tube within the micro-chamber, or molded into the micro-chamber itself. The micro-insert plunger 325 can also include a calibration scale 335 which can be used to gauge distances in a soft body lure with a non-transparent, non-translucent body such that a micro-insert can be precisely positioned within the soft bait lure.

As an example, the concave tip 330 of the micro-insert plunger 325 can be a cavity which is capable of gripping a micro-insert. The micro-insert plunger 325 can be used to push the micro-insert into place within a micro-chamber. Because the FBRS can be expandable, the FBRS and/or micro-chamber can expand upon insertion of the micro-insert such that the micro-insert can be held firmly in place by friction. In an exemplary embodiment, the micro-insert can be removed by using the micro-insert plunger 325 to push the micro-insert out of the micro-chamber. As such, micro-inserts can be mix and match inserts which allow a fisherman to easily customize his/her soft bait lure while in the field. In a soft bait lure with a closed micro-chamber, the fisherman can use the micro-insert plunger 325 to push a micro-insert through the micro-chamber filling to insert the micro-insert within the micro-chamber. In an exemplary embodiment, micro-inserts can be inserted from either end of the FBRS.

FIG. 23 illustrates a plurality of micro-inserts in accordance with an exemplary embodiment. FIG. 23 also illustrates a soft bait lure 340 in which a micro-insert 345 has been inserted into an open micro-chamber 350 in accordance with an exemplary embodiment. In alternative embodiments, micro-chambers can be molded or otherwise placed into closed micro-chambers. In an exemplary embodiment, the micro-insert 345 can be locked in place by a hollow tube 352 within the open micro-chamber 350. The hollow tube 352 can include notches to hold the micro-insert 345 place. Alternatively, hollow tube 352 can be expandable such that the micro-insert 345 can be oversized and held in place by friction. The micro-insert 345 can also be locked into place by the expandable apertures of an FBRS 354 or notches which are molded into the micro-chamber 350. The FBRS 354 can be expandable and the micro-insert 345 can be oversized such that the micro-insert 345 is held in place by friction.

The micro-inserts which can be inserted into a soft bait lure can include a chum-flavored and/or scented insert 355 to attract fish. In an alternative embodiment, a flavor and/or a scent can be incorporated into the body of the soft bait lure, into the FBRS 354, into micro-fiber flocking used to strengthen the soft bait lure, and/or into the fill of a closed micro-chamber. Other micro-inserts can include a float insert 360 to allow the soft bait lure to float, a sinker insert 365 to cause the soft body lure to sink, a light insert 370 to attract fish in low light and/or night conditions, and a rattle insert 375 to attract fish by sound. In alternative embodiments, any other types of micro-inserts which can attract fish and/or affect the properties of the soft bait lure can be used. For example, scent inserts and/or flavor inserts of any variety can be used, any other type of sound-generating inserts can be used, any other light-generating inserts can be used, etc. In an exemplary embodiment, one or more micro-inserts can be placed into any open micro-chamber or sub-chamber within an FBRS. Alternatively, one or more micro-inserts can be molded or otherwise placed into any closed micro-chamber of the FBRS. In an exemplary embodiment, the micro-inserts can be inserted by a user using the micro-insert plunger 325 described with reference to FIG. 22. Alternatively, the micro-inserts can be molded into the soft bait lure by the lure manufacturer. In an exemplary embodiment, a micro-insert can refer to any object which is at least partially inserted into a soft bait lure. As such a micro-insert can refer to a hook, fishing line, the above-described micro-inserts, etc.

FIG. 24 is a cross sectional view of a worm-shaped soft bait lure 400 which includes micro-inserts in accordance with an exemplary embodiment. The worm-shaped soft bait lure 400 includes a rattle insert 405, a chum-flavored insert 410, and a sinker insert 415 within an open micro-chamber 420 of a fiber braid reinforcement shell 425. In alternative embodiments, the worm-shaped soft bait lure 400 can include fewer, additional, and/or different micro-inserts.

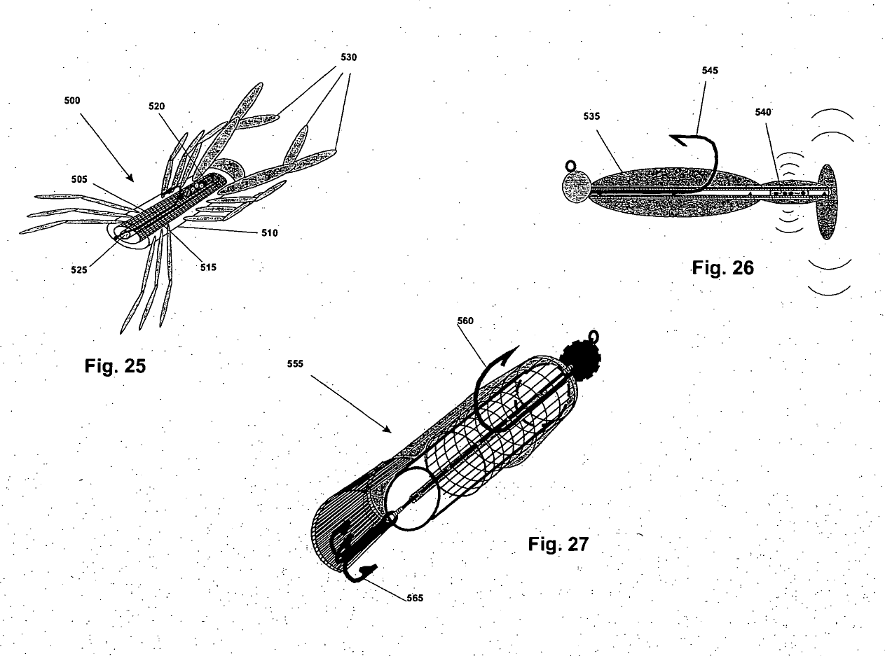

In an exemplary embodiment, soft bait lures which include an FBRS can be created to resemble any live bait or other object which is capable of attracting a fish. For example, FIG. 25 is an internal perspective view of a crawfish soft bait lure 500 in accordance with an exemplary embodiment. The crawfish soft bait lure 500 includes an FBRS 505 in a tube-shaped body 510. A hook 515 and a micro-insert 520 are locked in place within a micro-chamber 525 of the FBRS 505. The crawfish soft bait lure 500 also includes a plurality of legs 530 which extend from the tube-shaped body 510. In an alternative embodiment, one or more of the plurality of legs 530 can include an FBRS. In one embodiment, the FBRS in the legs 530 can be connected to the FBRS 505 in the tube-shaped body 510 such that the legs 530 cannot be bitten off by a fish. Alternatively, the FBRS in the legs 530 may not be connected to the FBRS 505 in the tube-shaped body 510.

FIG. 26 is a side view of a shad soft bait lure 535 in accordance with an exemplary embodiment. The shad soft bait lure 535 includes a rattle insert 540 and a hook 545. FIG. 27 is a cut-away perspective view of a solid resilient tube-shaped soft bait lure 555 in accordance with an exemplary embodiment. The tube-shaped soft bait lure 555 includes a hook 560 and a treble hook 565. In alternative embodiments, a soft bait lure with one or more FBRSs can mimic a grub, a fry, a lizard, a salamander, an eel, a snake, a frog, a squid, a plant, a bait fish of any size, or any other object or animal which is capable of attracting a fish.

The foregoing description of exemplary embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A soft bait fishing lure comprising:
a soft bait lure body; and
a fiber reinforcement shell molded within at least a portion of the soft bait lure body, wherein the fiber reinforcement shell is multi-directionally flexible, and further wherein the fiber reinforcement shell comprises
one or more fiber strands;
a plurality of apertures formed by the one or more fiber strands, wherein each aperture within the plurality of apertures is capable of securing a hook; and
a micro-chamber.

2. The soft bait fishing lure of claim 1, wherein the fiber reinforcement shell comprises a circular reinforcement shell.

3. The soft bait fishing lure of claim 1, wherein the fiber reinforcement shell comprises an ovular reinforcement shell.

4. The soft bait fishing lure of claim 1, wherein the micro-chamber comprises a closed micro-chamber.

5. The soft bait fishing lure of claim 4, wherein a micro-insert is molded into the closed micro-chamber.

6. The soft bait fishing lure of claim 4, wherein at least a portion of a hook is molded into the closed micro-chamber.

7. The soft bait fishing lure of claim 1, wherein the micro-chamber comprises an open micro-chamber capable of receiving a micro-insert.

8. The soft bait fishing lure of claim 7, wherein the open micro-chamber comprises a hollow tube capable of receiving a micro-insert.

9. The soft bait fishing lure of claim 8, wherein the hollow tube is notched such that the micro-insert can be locked in place.

10. The soft bait fishing lure of claim 1, further comprising the hook, wherein hook comprises a curved portion and further wherein at least a portion of the hook is located within the micro-chamber.

11. The soft bait fishing lure of claim 10, wherein the hook is secured to the fiber reinforcement shell through contact between the curved portion of the hook and at least one of the plurality of fibers.

12. The soft bait fishing lure of claim 10, wherein the hook further comprises a barb, and further wherein the hook is secured to the fiber reinforcement shell through contact between the barb and at least one of the plurality of fibers.

13. The soft bait fishing lure of claim 1, further comprising a micro-insert capable of being placed or molded within the micro-chamber.

14. The soft bait fishing lure of claim 13, wherein the micro-insert comprises a flavored micro-insert.

15. The soft bait fishing lure of claim 13, wherein the micro-insert comprises a sound-generating micro-insert.

16. The soft bait fishing lure of claim 13, wherein the micro-insert comprises a light-generating micro-insert.

17. The soft bait fishing lure of claim 13, wherein the micro-insert comprises a sinker micro-insert.

18. The soft bait fishing lure of claim 13, wherein the micro-insert comprises a float micro-insert.

19. The soft bait fishing lure of claim 13, wherein the micro-insert comprises a scented micro-insert.

20. The soft bait fishing lure of claim 1, wherein the fiber reinforcement shell comprises a tapered reinforcement shell.

21. The soft bait fishing lure of claim 1, wherein the fiber reinforcement shell comprises a multi-diameter reinforcement shell.

22. The soft bait fishing lure of claim 1, further comprising a second fiber reinforcement shell.

23. The soft bait fishing lure of claim 22, wherein the second fiber reinforcement shell is located within the fiber reinforcement shell such that a layered fiber reinforcement shell is formed.

24. The soft bait fishing lure of claim 22, wherein the second fiber reinforcement shell is located external to the fiber reinforcement shell.

25. The soft bait fishing lure of claim 1, wherein the soft bait lure body comprises an elastomer.

26. The soft bait fishing lure of claim 25, wherein a flavor is incorporated into the elastomer.

27. The soft bait fishing lure of claim 25, wherein a micro-fiber flocking reinforcement is incorporated into the elastomer.

28. The soft bait fishing lure of claim 1, wherein a flavor is incorporated into the fiber reinforcement shell.

29. A fiber reinforcement shell for use in a soft bait fishing lure comprising:
one or more fiber strands;
a plurality of apertures formed by the one or more fiber strands, wherein each aperture within the plurality of apertures is capable of receiving at least a portion of a hook, and further wherein the plurality of apertures is multi-directionally flexible; and
a micro-chamber formed at least in part by the plurality of apertures, wherein the micro-chamber is capable of receiving a micro-insert.

30. The fiber reinforcement shell of claim 29, further comprising a shimmer coating applied to at least one of the one or more fiber strands.

31. The fiber reinforcement shell of claim 29, wherein the micro-chamber includes one or more notches capable of securing an insert.

32. The fiber reinforcement shell of claim 29, wherein the micro-chamber comprises a plurality of sub-chambers, wherein each sub-chamber in the plurality of sub-chambers is capable of receiving a micro-insert.

33. A soft bait fishing system comprising:
a soft bait fishing lure comprising
a soft bait lure body comprising an elastomer; and
a fiber reinforcement shell molded within at least a portion of the soft bait lure body, wherein the fiber reinforement shell comprises one or more fiber strands, a plurality of apertures formed by the one or more fiber strands, and a micro-chamber capable of receiving a micro-insert; and
a hook comprising a curved portion.

34. The soft bait fishing system of claim 33, further comprising a micro-insert plunger capable of inserting the micro-insert into the micro-chamber.

35. The soft bait fishing system of claim 34, wherein the micro-insert plunger further comprises a concave end capable of receiving the micro-insert.

36. The soft bait fishing system of claim 34, wherein the micro-insert plunger further comprises a calibration scale such that a user can determine a location within the micro-chamber.

37. The soft bait fishing system of claim 33, further comprising a line threading mechanism capable of inserting fishing line into at least a portion of the micro-chamber.

38. The soft bait fishing system of claim 37, wherein the line threading mechanism comprises a line receiving aperture capable of receiving the fishing line.

39. The soft bait fishing system of claim 37, wherein the line threading mechanism comprises a calibration scale such that a user can determine a location within the micro-chamber.

40. The soft bait fishing system of claim 37, wherein the line threading mechanism is further capable of setting the hook within the soft bait fishing lure.

41. The soft bait fishing system of claim 33, further comprising the micro-insert.

42. The soft bait fishing system of claim 33, wherein the hook is secured to the fiber reinforcement shell through contact between the curved portion of the hook and at least one of the one or more fiber strands.

43. The soft bait fishing system of claim 33, wherein the hook further comprises a barb, and further wherein the hook is secured to the fiber reinforcement shell through contact between the barb and at least one of the one or more fiber strands.

44. The soft bait fishing system of claim 33, wherein the soft bait fishing lure comprises a soft bait component capable of being used within a hybrid fishing lure.
